(19) United States
(12) Patent Application Publication
(10) Pub. No.: US 2021/0339484 A1
(43) Pub. Date: Nov. 4, 2021

(54) A PANEL CONSTRUCTION, A PROCESS FOR PREPARING THE SAME AND USE THEREOF AS AN AUTOMOTIVE PART

(71) Applicant: BASF SE, Ludwigshafen am Rhein (DE)

(72) Inventors: Elias Ruda Shakour, Wyandotte, MI (US); Robert Lyons, Wyandotte, MI (US); Brian E. Shaner, Wyandotte, MI (US); Todd A. Seaver, Wyandotte, MI (US)

(21) Appl. No.: 17/262,326

(22) PCT Filed: Jul. 26, 2019
(86) PCT No.: PCT/EP2019/070182

§ 371 Date: Jan. 22, 2021

Related U.S. Application Data
(60) Provisional application No. 62/703,935, filed on Jul. 27, 2018.

(30) Foreign Application Priority Data
Aug. 30, 2018 (EP) 18191711.3

(51) Int. Cl. B29C 70/46; B29C 70/00; B29B 15/12; C08G 18/76; C08G 18/48

(52) U.S. Cl. CPC B29C 70/46; B29C 70/003; B29K 2075/00; C08G 18/7671; C08G 18/4829; B29B 15/127

(57) ABSTRACT

Described herein is a panel construction, a process for preparing the same and a method of using the same as an automotive part.

### FIELD OF INVENTION

The present invention relates to a process for preparing a panel construction and use thereof as an automotive part.

### BACKGROUND OF THE INVENTION

Structural thermoset composites are a desirable material for the automotive industry due to their light weight and higher strength, in comparison to other materials. Panel constructions are shaped parts which are used as structural reinforcement for automotives. These composites are generally produced using resin transfer molding (RTM) techniques, wherein a thermoset resin saturates a fiber mat layer in a closed mold.

These composites and the process for producing them are well-known in the state of the art. Additionally, honeycomb sandwich panels have also been extensively used in the automotive industry. Honeycomb sandwich panels comprise of two thin and hard surface sheets bonded to a thick and lightweight honeycomb structured core. Although, the honeycomb structure provides for good mechanical properties, it has limited applicability due to the increased thickness of the resulting panel.

The existing state of the art panel constructions for application in the automotive industry have further limitations. The speed of production or the processing time to produce an automotive part is high due to the complexity involved in preparing the panel constructions using the existing techniques, such as RTM. Moreover, the alignment of fiber, extent of fiber wetting and the thickness of the final composite is also a challenge to maintain. Particularly, the incomplete fiber wetting, especially on the edges of the fiber mat layer, result in an inappropriately reinforced structure.

Thus, it was an object of the present invention to provide a panel construction with reduced thickness, which requires lesser processing time due to less complexity of the manufacturing technique and ensures full wetting of the fibers, thereby resulting in strong, lightweight and less costly materials for automotive parts, particularly for use as a lower sound shield, acoustical belly pan, aero shield, splash shield, underbody panel, chassis shield, door module, rear package shelf and leaf spring.

### SUMMARY OF THE INVENTION

Surprisingly, it has been found that the above object is met by providing a panel construction wherein a polyurethane resin composition is sprayed onto at least one fiber mat layer.

In another aspect, the present invention is directed to a process for preparing a panel construction, said process comprising the steps of:
(S1) spraying a polyurethane resin composition onto at least one fiber mat layer, wherein said polyurethane resin composition is obtained by reacting:
   (a) an isocyanate, and
   (b) a compound reactive towards isocyanate;
   wherein (a) and (b) are present at an isocyanate index in between 100 to 150, and
   wherein said polyurethane resin composition forms a polyurethane film on the at least one fiber mat layer,
and resulting in a pre-impregnated blank,
and
(S2) compression molding the pre-impregnated blank and resulting in the panel construction.

In another aspect, the present invention is directed to a panel construction obtained from the abovementioned process.

In another aspect, the present invention is directed to the use of the abovementioned panel construction as an automotive part.

In another aspect, the present invention is directed to a lower sound shield comprising the abovementioned panel construction.

In another aspect, the present invention is directed to an acoustical belly pan comprising the abovementioned panel construction.

In another aspect, the present invention is directed to an aero shield comprising the abovementioned panel construction.

In another aspect, the present invention is directed to a splash shield comprising the abovementioned panel construction.

In another aspect, the present invention is directed to an underbody panel comprising the abovementioned panel construction.

In another aspect, the present invention is directed to a chassis shield comprising the abovementioned panel construction.

In another aspect, the present invention is directed to a rear package shelf comprising the abovementioned panel construction.

In another aspect, the present invention is directed to a leaf spring comprising the abovementioned panel construction.

In another aspect, the present invention is directed to an automotive part comprising the abovementioned panel construction.

### DETAILED DESCRIPTION OF THE INVENTION

Before the present compositions and formulations of the invention are described, it is to be understood that this invention is not limited to particular compositions and formulations described, since such compositions and formulation may, of course, vary. It is also to be understood that the terminology used herein is not intended to be limiting, since the scope of the present invention will be limited only by the appended claims.

The terms “comprising”, “comprises” and “comprised of” as used herein are synonymous with “including”, “includes” or “containing”, “contains”, and are inclusive or open-ended and do not exclude additional, non-recited members, elements or method steps. It will be appreciated that the terms “comprising”, “comprises” and “comprised of” as used herein comprise the terms “consisting of”, “consists” and “consists of”.

Furthermore, the terms “first”, “second”, “third” or “(a)”, “(b)”, “(c)”, “(d)” etc. and the like in the description and in the claims, are used for distinguishing between similar elements and not necessarily for describing a sequential or chronological order. It is to be understood that the terms so used are interchangeable under appropriate circumstances and that the embodiments of the invention described herein are capable of operation in other sequences than described or illustrated herein. In case the terms “first”, “second”, “third” or “(A)”, “(B)” and “(C)” or “(a)”, “(b)”, “(c)”, “(d)”, “i”, “ii” etc. relate to steps of a method or use or assay there is no time or time interval coherence between the steps, that is, the steps may be carried out simultaneously or there may be time intervals of seconds, minutes, hours, days, weeks, months or even years between such steps, unless otherwise indicated in the application as set forth herein above or below.

In the following passages, different aspects of the invention are defined in more detail. Each aspect so defined may be combined with any other aspect or aspects unless clearly indicated to the contrary. In particular, any feature indicated as being preferred or advantageous may be combined with any other feature or features indicated as being preferred or advantageous.

Reference throughout this specification to “one embodiment” or “an embodiment” means that a particular feature, structure or characteristic described in connection with the embodiment is included in at least one embodiment of the present invention. Thus, appearances of the phrases “in one embodiment” or “in an embodiment” in various places throughout this specification are not necessarily all referring to the same embodiment, but may. Furthermore, the particular features, structures or characteristics may be combined in any suitable manner, as would be apparent to a person skilled in the art from this disclosure, in one or more embodiments. Furthermore, while some embodiments described herein include some but not other features included in other embodiments, combinations of features of different embodiments are meant to be within the scope of the invention, and form different embodiments, as would be understood by those in the art. For example, in the appended claims, any of the claimed embodiments can be used in any combination.

Furthermore, the ranges defined throughout the specification include the end values as well, i.e. a range of 1 to 10 implies that both 1 and 10 are included in the range. For the avoidance of doubt, the applicant shall be entitled to any equivalents according to applicable law.

An aspect of the present invention relates to a process for preparing a panel construction, comprising the steps of:

(S1) spraying a polyurethane resin composition onto at least one fiber mat layer, wherein said polyurethane resin composition is obtained by reacting:
(a) an isocyanate, and
(b) a compound reactive towards isocyanate;
wherein (a) and (b) are present at an isocyanate index in between 100 to 150, and
wherein said polyurethane resin composition forms a polyurethane film on the at least one fiber mat layer;
and resulting in a pre-impregnated blank,

and

(S2) compression molding the pre-impregnated blank and resulting in the panel construction.

In one embodiment, the panel construction is a monolithic composite, also referred to as monolithic panel construction or a single-layer system, comprising the at least one fiber mat layer and the polyurethane film, as described hereinabove. The term “monolithic panel construction” refers to the panel construction comprising at least one fiber mat layer and no other layer, particularly no honeycomb structure.

In another embodiment, the said polyurethane film is prepared from the polyurethane resin composition which is sprayed onto the fiber mat layer. In the present context, the term “polyurethane film” refers to the atomized polyurethane resin composition which, when sprayed onto the fiber mat layer, binds itself to the fiber mat layer and has no thickness of its own. That is, to say, that the polyurethane film does not exists as a separate layer onto the fiber mat layer. Also, the term “atomized” herein refers to the particles or droplets of the polyurethane resin composition obtained from suitable spraying means, such as but not limited to a nozzle or an atomizer.

In another embodiment, the panel construction has a thickness preferably in between 1 mm to 30 mm, or in between 1 mm to 20 mm or in between 1 mm to 10 mm.

The fiber mat layer, as described hereinabove, comprises of non-woven fibers or fabric, woven fabrics or non-crimp fabrics. In one embodiment, the fiber mats comprise non-woven fibers.

The fibers are natural, synthetic or glass fibers. Synthetic fibers are for instance carbon fibers or polyester fibers. Natural fibers are for instance cellulosic bast fibers. The non-woven fibers can also contain a small amount of synthetic thermoplastic fiber, for instance polyethylene terephthalate fibers (PET). The fibers can be synthetic polyester fibers or other fibers or similar characteristics.

In one embodiment, the fiber mat layer is made of glass fibers. The presence of glass fibers embedded in the panel construction dramatically improves its dimensional stability, while all other desirable mechanical and processing properties are maintained. Suitable glass fiber mat layers are well known to the person skilled in the art. For example, chopped glass fibers and continuous glass fibers can be used for this purpose.

In another embodiment, the fiber mat layer is obtained from chopped glass fibers. The chopped glass fibers can be obtained in any shape and size. For instance, the chopped glass fibers can be, such as, but not limited to, a strand of fiber having a lateral and through-plane dimension or a spherical particle having diameter. The present invention is not limited by the choice of the shape and size of the chopped glass fibers as the person skilled in the art is aware of the same. In one embodiment, the chopped glass fiber has a length in between 10 mm to 150 mm, or in between 10 mm to 130 mm, or in between 10 mm to 100 mm.

Although, any suitable binding agent can be used for binding the chopped glass fibers, preferred is an acrylic binder. The acrylic binder is a cured aqueous based acrylic resin. The binder cures, for instance, through carboxylic groups and a multi-functional alcohol.

Acrylic binders are polymers or copolymers containing units of acrylic acid, methacrylic acid, their esters or related derivatives. The acrylic binders are for instance formed by aqueous emulsion polymerization employing (meth)acrylic acid (where the convention (meth)acrylic is intended to embrace both acrylic and methacrylic), 2-hydroxyethyl(meth)acrylate, 2-hydroxypropyl(meth)acrylate, 2-hydroxybutyl(meth)acrylate, methyl(meth)acrylate, ethyl(meth)acrylate, propyl(meth)acrylate, isopropyl(meth)acrylate, butyl(meth)acrylate, amyl(meth)acrylate, isobutyl(meth)acrylate, t-butyl(meth)acrylate, pentyl(meth)acrylate, isoamyl(meth)acrylate, hexyl(meth)acrylate, heptyl(meth)acrylate, octyl(meth)acrylate, isooctyl(meth)acrylate, 2-ethylhexyl(meth)acrylate, nonyl(meth)acrylate, decyl(meth)acrylate, isodecyl(meth)acrylate, undecyl(meth)acrylate, dodecyl(meth)acrylate, lauryl(meth)acrylate, octadecyl(meth)acrylate, stearyl(meth)acrylate, tetrahydrofurfuryl(meth)acrylate, butoxyethyl(meth)acrylate, ethoxydiethylene glycol (meth)acrylate, benzyl(meth)acrylate, cyclohexyl(meth)acrylate, phenoxyethyl(meth)acrylate, polyethylene glycol mono(meth)acrylate, polypropylene glycol mono(meth)acrylate, methoxyethylene glycol (meth)acrylate, ethoxyethoxyethyl(meth)acrylate, methoxypolyethylene glycol (meth)acrylate, methoxypolypropylene glycol (meth)acrylate, dicyclopentadiene(meth)acrylate, dicyclopentanyl(meth)acrylate, tricyclodecanyl(meth)acrylate, isobornyl(meth)acrylate, bornyl(meth)acrylate or mixtures thereof.

Other monomers which can be co-polymerized with the (meth)acrylic monomers, generally in a minor amount, include styrene, diacetone(meth)acrylamide, isobutoxymethyl(meth)acrylamide, N-vinylpyrrolidone, N-vinylcaprolactam, N,N-dimethyl(meth)acrylamide, t-octyl(meth)acrylamide, N,N-di-ethyl(meth)acrylamide, N,N′-dimethyl-aminopropyl(meth)acrylamide, (meth)acryloylmorphorine; vinyl ethers such as hydroxybutyl vinyl ether, lauryl vinyl ether, cetyl vinyl ether, and 2-ethylhexyl vinyl ether; maleic acid esters; fumaric acid esters and similar compounds.

Multi-functional alcohols are for instance hydroquinone, 4,4′-dihydroxydiphenyl, 2,2-bis(4-hydroxyphenyl)propane, cresols or alkylene polyols containing 2 to 12 carbon atoms, including ethylene glycol, 1,2- or 1,3-propanediol, 1,2-, 1,3- or 1,4-butanediol, pentanediol, hexanediol, octanediol, dodecanediol, diethylene glycol, triethylene glycol, 1,3-cyclopentanediol, 1,2-, 1,3- or 1,4-cyclohexanediol, 1,4-dihydroxymethylcyclohexane, glycerol, tris(β-hydroxyethyl)amine, trimethylolethane, trimethylolpropane, pentaerythritol, dipentaerythritol, tripentaerythritol and sorbitol.

The aqueous based acrylic binders are commercially available under the ACRODUR® name from BASF.

The aqueous based acrylic resin is infused in the fiber mat. That is to say, the fiber mat is impregnated with the acrylic resin. The fiber mats are compressed and cured with heat and pressure. Pressure is not required for curing, but for setting a desired thickness or density or shape. Forming takes place for instance in a heated, shaped tool to a desired shape.

The aqueous based acrylic binder may be applied to the non-woven fibers or fabrics either through a dip-and-squeeze method, a curtain coater or a foam injection method. The mixture is dried to a low moisture content, preferably in an amount in between 4.0 wt.-% to 7.0 wt.-%, prior to thermal curing. This is the fiber mat prepreg.

During initial heating and compression, compression release allows moisture to vent. The number of releases depends on the amount of moisture contained in the un-cured mat. The cured fiber mat does not contain significant amounts of water. In one embodiment, the amount of water is in between 0 wt.-% to 3.0 wt.-% or based on the dry weight of the fiber mat layer.

Once cured, the fiber mat does not significantly swell. A preferred mat basis weight is in between 100 grams/square meter (gsm) to 1400 grams/square meter. The acrylic resin loading is in between 15 wt.-% to 50 wt.-%, or in between 20 wt.-% to 40 wt.-% of dried resin, based on the finished mat weight.

In another embodiment, if the fiber mat layer is made from continuous glass fibers, use of the binding agents, as described hereinabove, can be avoided. The present invention is not limited by the choice of the shape and size of the continuous glass fibers as the person skilled in the art is aware of the same.

The continuous glass fibers can be oriented in one direction or in several directions, for instance, lateral, perpendicular or any angle between lateral and perpendicular. The fiber mat layer comprising of continuous glass fibers has a nominal weight preferably in between 100 g/m² to 1000 g/m².

In yet another embodiment, the fiber mat layer can be a hybrid layer comprising of at least one layer of chopped glass fibers and at least one layer of continuous glass fibers. In one embodiment, it can also contain a thin film or scrim to enhance surface quality. The said thin film or scrim can be inserted on top of the hybrid layer.

The fiber mat layer, as described hereinabove, has an area weight in between 100 g/m² to 1500 g/m² and a thickness in between 1 mm to 30 mm. Suitable techniques to measure the area weight and thickness are well known to the person skilled in the art.

In another embodiment, the panel construction can also comprise more than one fiber mat layer, e.g. two, three, four or five fiber mat layers to form a multi-layered system. In such a case, the fiber mats can be identical or different. They can be of the same basis weight or thickness or be of different basis weight or thickness. Also, the fibers employed in the multi-layered system can be same or different. The choice and selection of the number of layers and the fiber mat therefor is well known to the person skilled in the art. In such an embodiment, the polyurethane resin composition is sprayed onto each of the fiber mat layer to obtain the polyurethane film. The fiber mat layers may optionally comprise of suitable adhesives to bind them together, however, there is no adhesive between the fiber mat layer and the polyurethane film. Suitable adhesives for binding the fiber mat layers are well known to the person skilled in the art.

The polyurethane film, as described hereinabove, is prepared from the polyurethane resin composition obtained by reacting:

(a) the isocyanate, and

(b) the compound reactive towards isocyanate,

wherein (a) and (b) are present at the isocyanate index in between 100 to 150.

In one embodiment, the polyurethane resin composition forms the matrix structure of the panel construction.

For the purpose of the present invention, the isocyanate has an average functionality of at least 2.0; or in between 2.0 to 3.0. These isocyanates can be selected from aliphatic isocyanates, aromatic isocyanates and a combination thereof By the term “aromatic isocyanate”, it is referred to molecules having two or more isocyanate groups attached directly and/or indirectly to the aromatic ring. Further, it is to be understood that the isocyanate includes both monomeric and polymeric forms of the aliphatic and aromatic isocyanate. By the term “polymeric”, it is referred to the polymeric grade of the aliphatic and/or aromatic isocyanate comprising, independently of each other, different oligomers and homologues.

In another embodiment, the isocyanate comprises an aromatic isocyanate selected from toluene diisocyanate; polymeric toluene diisocyanate, methylene diphenyl diisocyanate; polymeric methylene diphenyl diisocyanate; m-phenylene diisocyanate; 1,5-naphthalene diisocyanate; 4-chloro-1; 3-phenylene diisocyanate; 2,4,6-toluylene triisocyanate, 1,3-diisopropylphenylene-2,4-diisocyanate; 1-methyl-3,5-diethylphenylene-2,4-diisocyanate; 1,3,5-triethylphenylene-2,4-diisocyanate; 1,3,5-triisoproply-phenylene-2,4-diisocyanate; 3,3′-diethyl-bisphenyl-4,4′-diisocyanate; 3,5,3′,5′-tetraethyl-diphenylmethane-4,4′-diisocyanate; 3,5,3′,5′-tetraisopropyldiphenylmethane-4,4′-diisocyanate; 1-ethyl-4-ethoxy-phenyl-2,5-diisocyanate; 1,3,5-triethylbenzene-2,4,6-triisocyanate; 1-ethyl-3,5-diisopropyl benzene-2,4,6-triisocyanate, tolidine diisocyanate, 1,3,5-triisopropyl benzene-2,4,6-triisocyanate and mixtures thereof. In other embodiment, the aromatic isocyanate is selected from toluene diisocyanate; polymeric toluene diisocyanate, methylene diphenyl diisocyanate; polymeric methylene diphenyl diisocyanate, m-phenylene diisocyanate; 1,5-naphthalene diisocyanate; 4-chloro-1; 3-phenylene diisocyanate; 2,4,6-toluylene triisocyanate, 1,3-diisopropylphenylene-2,4-diisocyanate and 1-methyl-3,5-diethylphenylene-2,4-diisocyanate. In other embodiments, the aromatic isocyanate is selected from toluene diisocyanate; polymeric toluene diisocyanate, methylene diphenyl diisocyanate; polymeric methylene diphenyl diisocyanate, m-phenylene diisocyanate and 1,5-naphthalene diisocyanate or a combination thereof. In still other embodiment, the aromatic isocyanate is selected from toluene diisocyanate; polymeric toluene diisocyanate, methylene diphenyl diisocyanate and polymeric methylene diphenyl diisocyanate. In one embodiment, the aromatic isocyanate comprises methylene diphenyl diisocyanate and/or polymeric methylene diphenyl diisocyanate.

Methylene diphenyl diisocyanate is available in three different isomeric forms, namely 2,2′-methylene diphenyl diisocyanate (2,2′-MDI), 2,4′-methylene diphenyl diisocyanate (2,4′-MDI) and 4,4′-methylene diphenyl diisocyanate (4,4′-MDI). Methylene diphenyl diisocyanate can be classified into monomeric methylene diphenyl diisocyanate and polymeric methylene di-phenyl diisocyanate referred to as technical methylene diphenyl diisocyanate. Polymeric methylene diphenyl diisocyanate includes oligomeric species and methylene diphenyl diisocyanate isomers. Thus, polymeric methylene diphenyl diisocyanate may contain a single methylene diphenyl diisocyanate isomer or isomer mixtures of two or three methylene diphenyl diisocyanate isomers, the balance being oligomeric species. Polymeric methylene diphenyl diisocyanate tends to have isocyanate functionalities of higher than 2. The isomeric ratio as well as the amount of oligomeric species can vary in wide ranges in these products. For instance, polymeric methylene diphenyl diisocyanate may typically contain 30 wt.-% to 80 wt.-% of methylene diphenyl diisocyanate isomers, the balance being said oligomeric species. The methylene diphenyl diisocyanate isomers are often a mixture of 4,4′-methylene diphenyl diisocyanate, 2,4′-methylene diphenyl diisocyanate and very low levels of 2,2′-methylene di-phenyl diisocyanate.

In addition, reaction products of polyisocyanates with polyhydric polyols and their mixtures with other diisocyanates and polyisocyanates can also be used.

In one embodiment, the isocyanate comprises a polymeric methylene diphenyl diisocyanate. Commercially available isocyanates available under the tradename, such as, but not limited to, Lupranat□ from BASF can also be used for the purpose of the present invention.

Suitable compounds that are reactive towards isocyanate include compounds having a molecular weight of 400 g/mol or more and chain extenders and/or cross linkers having molecular weight in between 49 g/mol to 399 g/mol.

In one embodiment, the compounds being reactive towards isocyanate and having a molecular weight of 400 g/mol or more are compounds having hydroxyl groups, also referred to as polyol. Suitable polyols have an average functionality preferably in between 2.0 to 8.0, or in between 2.0 to 6.5, or in between 2.5 to 6.5 and a hydroxyl number preferably in between 15 mg KOH/g to 1800 mg KOH/g, or in between 15 mg KOH/g to 1500 mg KOH/g, or even between 100 mg KOH/g to 1500 mg KOH/g.

The compounds that are reactive towards isocyanate can be present in the polyurethane resin composition in amounts preferably in between 1 wt.-% to 99 wt.-%, based on the total weight of the polyurethane resin composition.

In one embodiment, the polyols are selected from polyether polyols, polyester polyols, polyether-ester polyols and a combination thereof.

In another embodiment, the polyol comprises polyether polyols. In yet another embodiment, the polyol comprises a mixture of polyether polyols and polyester polyols.

Polyether polyols, according to the invention, have an average functionality in between 2.0 to 8.0, or in between 2.5 to 6.5, or in between 2.5 to 5.5, and a hydroxyl number in between 15 mg KOH/g to 1500 mg KOH/g, or in between 100 mg KOH/g to 1500 mg KOH/g, or even between 250 mg KOH/g to 1000 mg KOH/g.

In another embodiment, the polyether polyols are obtainable by known methods, for example by anionic polymerization with alkali metal hydroxides, e.g., sodium hydroxide or potassium hydroxide, or alkali metal alkoxides, e.g., sodium methoxide, sodium ethoxide, potassium ethoxide or potassium isopropoxide, as catalysts and by adding at least one amine-containing starter molecule, or by cationic polymerization with Lewis acids, such as antimony pentachloride, boron fluoride etherate and so on, or fuller's earth, as catalysts from one or more alkylene oxides having 2 to 4 carbon atoms in the alkylene moiety.

Starter molecules are generally selected such that their average functionality is preferably in between 2.0 to 8.0, or in between 3.0 to 8.0. Optionally, a mixture of suitable starter molecules is used.

Starter molecules for polyether polyols include amine containing and hydroxyl-containing starter molecules. Suitable amine containing starter molecules include, for example, aliphatic and aromatic diamines such as ethylenediamine, propylenediamine, butylenediamine, hexamethylenediamine, phenylenediamines, toluenediamine, diaminodiphenylmethane and isomers thereof.

Other suitable starter molecules further include alkanolamines, e.g. ethanolamine, N-methylethanolamine and N-ethylethanolamine, dialkanolamines, e.g., diethanolamine, N-methyldiethanolamine and N-ethyldiethanolamine, and trialkanolamines, e.g., triethanolamine, and ammonia.

Suitable amine containing starter molecules are selected from ethylenediamine, phenylenediamines, toluenediamine and isomers thereof In one embodiment, it is ethylenediamine.

Hydroxyl-containing starter molecules are selected from sugars, sugar alcohols, for e.g. glucose, mannitol, sucrose, pentaerythritol, sorbitol; polyhydric phenols, resols, e.g., oligomeric condensation products formed from phenol and formaldehyde, trimethylolpropane, glycerol, glycols such as ethylene glycol, propylene glycol and their condensation products such as polyethylene glycols and polypropylene glycols, e.g., diethylene glycol, triethylene glycol, dipropylene glycol, and water or a combination thereof.

Suitable hydroxyl containing starter molecules are selected from sugar and sugar alcohols such as sucrose, sorbitol, glycerol, pentaerythritol, trimethylolpropane and mixtures thereof. In some embodiments the hydroxyl containing starter molecules are selected from sucrose, glycerol, pentaerythritol and trimethylolpropane.

Suitable alkylene oxides having 2 to 4 carbon atoms are, for example, ethylene oxide, propylene oxide, tetrahydrofuran, 1,2-butylene oxide, 2,3-butylene oxide and styrene oxide. Alkylene oxides can be used singly, alternatingly in succession or as mixtures. In one embodiment, the alkylene oxides are propylene oxide and/or ethylene oxide. In some embodiments, the alkylene oxides are mixtures of ethylene oxide and propylene oxide that comprise more than 50 wt.-% of propylene oxide.

The amount of the polyether polyols is in between 1 wt.-% to 99 wt.-%, based on the total weight of the polyurethane resin composition, or in between 20 wt.-% to 99 wt.-%, or even in between 40 wt.-% to 99 wt.-%.

Suitable polyester polyols have an average functionality in between 2.0 to 6.0, or between 2.0 to 5.0, or between 2.0 to 4.0 and a hydroxyl number in between 30 mg KOH/g to 250 mg KOH/g, or between 100 mg KOH/g to 200 mg KOH/g.

Polyester polyols, according to the present invention, are based on the reaction product of carboxylic acids or anhydrides with hydroxy group containing compounds. Suitable carboxylic acids or anhydrides have preferably from 2 to 20 carbon atoms, or from 4 to 18 carbon atoms, for example succinic acid, glutaric acid, adipic acid, suberic acid, azelaic acid, sebacic acid, decanedicarboxylic acid, maleic acid, fumaric acid, phthalic acid, isophthalic acid, terephthalic acid, oleic acid, phthalic anhydride. Particularly comprising of phthalic acid, isophthalic acid, terephthalic acid, oleic acid and phthalic anhydride or a combination thereof

Suitable hydroxyl containing compounds are selected from ethanol, ethylene glycol, propylene-1,2-glycol, propylene-1,3-glycol, butyl-ene-1,4-glycol, butylene-2,3-glycol, hexane-1,6-diol, octane-1,8-diol, neopentyl glycol, cyclohexane dimethanol (1,4-bis-hydroxy-methylcyclohexane), 2-methyl-propane-1,3-diol, glycerol, trimethylolpropane, hex-ane-1,2,6-triol, butane-1,2,4-triol, trimethylolethane, pentaerythritol, quinitol, mannitol, sorbitol, methyl glycoside, diethylene glycol, triethylene glycol, tetraethylene glycol, polyethylene glycol, dipropylene glycol, polypropylene glycol, polyethylene-propylene glycol, dibutylene glycol and polybutylene glycol. In one embodiment, the hydroxyl containing compound is selected from ethylene glycol, propylene-1,2-glycol, propylene-1,3-glycol, butyl-ene-1,4-glycol, butylene-2,3-glycol, hexane-1,6-diol, octane-1,8-diol, neopentyl glycol, cyclohexane dimethanol (1,4-bis-hydroxy-methylcyclohexane), 2-methyl-propane-1,3-diol, glycerol, trimethylolpropane, hexane-1,2,6-triol, butane-1,2,4-triol, trimethylolethane, pentaerythritol, quinitol, mannitol, sorbitol, methyl glycoside and diethylene glycol. In another embodiment, the hydroxyl containing compound is selected from ethylene glycol, propylene-1,2-glycol, propylene-1,3-glycol, butyl-ene-1,4-glycol, butylene-2,3-glycol, hexane-1,6-diol, octane-1,8-diol, neopentyl glycol and diethylene glycol. In still another embodiment, the hydroxyl containing compound is selected from hexane-1,6-diol, neopentyl glycol and diethylene glycol.

Suitable polyether-ester polyols have a hydroxyl number in between 100 mg KOH/g to 460 mg KOH/g, or between 150 mg KOH/g to 450 mg KOH/g, or even between 250 mg KOH/g to 430 mg KOH/g and in any of these embodiments may have an average functionality in between 2.3 to 5.0, or even between 3.5 to 4.7.

Such polyether-ester polyols are obtainable as a reaction product of i) at least one hydroxyl-containing starter molecule; ii) of one or more fatty acids, fatty acid monoesters or mixtures thereof; iii) of one or more alkylene oxides having 2 to 4 carbon atoms.

The starter molecules of component i) are generally selected such that the average functionality of component i) is preferably 3.8 to 4.8, or from 4.0 to 4.7, or even from 4.2 to 4.6. Optionally, a mixture of suitable starter molecules is used.

Suitable hydroxyl-containing starter molecules of component i) are selected from sugars, sugar alcohols (glucose, mannitol, sucrose, pentaerythritol, sorbitol), polyhydric phenols, resols, e.g., oligomeric condensation products formed from phenol and formaldehyde, trimethylolpropane, glycerol, glycols such as ethylene glycol, propylene glycol and their condensation products such as polyethylene glycols and polypropylene glycols, e.g., diethylene glycol, triethylene glycol, dipropylene glycol, and water or a combination thereof.

In one embodiment, the hydroxyl-containing starter molecules of component i) are selected from sugars and sugar alcohols such as sucrose and sorbitol, glycerol, and mixtures of said sugars and/or sugar alcohols with glycerol, water and/or glycols such as, for example, diethylene glycol and/or dipropylene glycol.

Said fatty acid or fatty acid monoester ii) is selected from polyhydroxy fatty acids, ricinoleic acid, hydroxyl-modified oils, hydroxyl-modified fatty acids and fatty acid esters based in myristoleic acid, palmitoleic acid, oleic acid, stearic acid, palmitic acid, vaccenic acid, petroselic acid, gadoleic acid, erucic acid, nervonic acid, linoleic acid, a- and g-linolenic acid, stearidonic acid, arachidonic acid, timnodonic acid, clupanodonic acid and cervonic acid or a combination thereof. Fatty acids can be used as purely fatty acids. In this regard, preference is given to using fatty acid methyl esters such as, for example, biodiesel or methyl oleate.

Biodiesel is to be understood as meaning fatty acid methyl esters within the meaning of the EN 14214 standard from 2010. Principal constituents of biodiesel, which is generally produced from rapeseed oil, soybean oil or palm oil, are methyl esters of saturated C₁₆ to C₁₈ fatty acids and methyl esters of mono- or polyunsaturated C₁₈ fatty acids such as oleic acid, linoleic acid and linolenic acid.

Suitable alkylene oxides iii) having 2 to 4 carbon atoms are, for example, ethylene oxide, propylene oxide, tetrahydrofuran, 1,2-butylene oxide, 2,3-butylene oxide and/or styrene oxide. Alkylene oxides can be used singly, alternatingly in succession or as mixtures.

In one embodiment, the alkylene oxides comprise propylene oxide and ethylene oxide In other embodiment, the alkylene oxide is a mixture of ethylene oxide and propylene oxide comprising more than 50 wt.-% of propylene oxide. In another embodiment, the alkylene oxide comprises purely propylene oxide.

In one embodiment, suitable chain extenders and/or cross linkers can also be present in the polyurethane resin composition, as described hereinabove. The addition of bifunctional chain extenders, trifunctional and higher-functional cross linkers or, if appropriate, mixtures thereof might be added. Chain extenders and/or cross linkers used are preferably alkanol amines and in particular diols and/or triols having molecular weights preferably in between 60 g/mol to 300 g/mol. Suitable amounts of these chain extenders and/or cross linkers can be added and are known to the person skilled in the art. For instance, chain extenders and/or cross linkers can be present in an amount up to 99 wt.-%, or up to 20 wt.-%, based on the total weight of the polyurethane resin composition.

In another embodiment, commercially available compounds that are reactive towards isocyanate can also be employed, for e.g. Sovermol®, Pluracol® and Quadrol® from BASF.

In one embodiment, the isocyanates and the compounds reactive towards isocyanate, as described herein, are present at the isocyanate index in between 100 to 150. The isocyanate index of 100 corresponds to one isocyanate group per one isocyanate reactive group.

In another embodiment, the isocyanate index is in between 100 to 140, or in between 100 to 130, or in between 100 to 120. In another embodiment, it is in between 100 to 115, or in between 105 to 115.

In one embodiment, the polyurethane resin composition, as described herein, is a rigid polyurethane foam.

The polyurethane resin composition, as described hereinabove, further comprises catalysts and additives.

Suitable catalysts for the polyurethane resin composition are well known to the person skilled in the art. For instance, tertiary amine and phosphine compounds, metal catalysts such as chelates of various metals, acidic metal salts of strong acids; strong bases, alcoholates and phenolates of various metals, salts of organic acids with a variety of metals, organometallic derivatives of tetravalent tin, trivalent and pentavalent As, Sb and Bi and metal carbonyls of iron and cobalt and mixtures thereof can be used as catalysts.

Suitable tertiary amines include, such as triethylamine, tributylamine, N-methylmorpholine, N-ethylmorpholine, N,N,N′,N′-tetramethylethylenediamine, pentamethyl-diethylenetriamine and higher homologues (as described in, for example, DE-A 2,624,527 and 2,624,528), 1,4-diazabicyclo(2.2.2)octane, N-methyl-N′-dimethyl-aminoethylpiperazine, bis-(dimethylaminoalkyl)piperazines, tris(dimethylaminopropyl)hexahydro-1,3,5-triazin, N,N-dimethylbenzylamine, N,N-dimethyl-cyclohexylamine, N,N-diethyl-benzylamine, bis-(N,N-diethylaminoethyl) adipate, N,N,N′,N′-tetra-methyl-1,3-butanediamine, N,N-dimethyl-p-phenylethylamine, 1,2-dimethylimidazole, 2-methylimidazole, monocyclic and bicyclic amines together with bis-(dialkylamino)alkyl ethers, such as 2,2-bis-(dimethylaminoethyl)ether. Triazine compounds, such as, but not limited to, tris(dimethylaminopropyl)hexahydro-1,3,5-triazin can also be used.

Suitable metal catalysts include metal salts and organometallics comprising tin-, titanium-, zirconium-, hafnium, bismuth-, zinc-, aluminium- and iron compounds, such as tin organic compounds, preferably tin alkyls, such as dimethyltin or diethyltin, or tin organic compounds based on aliphatic carboxylic acids, preferably tin diacetate, tin dilaurate, dibutyl tin diacetate, dibutyl tin dilaurate, bismuth compounds, such as bismuth alkyls or related compounds, or iron compounds, preferably iron-(II)-acetylacetonate or metal salts of carboxylic acids, such as tin-II-isooctoate, tin dioctoate, titanium acid esters or bismuth-(III)-neodecanoate or a combination thereof.

The catalysts, as described hereinabove, can be present in amounts preferably up to 20 wt.-% based on the total weight of the polyurethane resin composition.

If present, additives can be selected from pigments, dyes, surfactants, flame retardants, hindered amine light stabilizers, ultraviolet light absorbers, stabilizers, defoamers, internal release agents, desiccants, blowing agents, curing agents and anti-static agents or a combination thereof. Further details regarding additives can be found, for example, in the Kunststoffhandbuch, Volume 7, “Polyurethane” Carl-Hanser-Verlag Munich, 1st edition, 1966 2nd edition, 1983 and 3rd edition, 1993. Suitable amounts of these additives are well known to the person skilled in the art. However, for instance, the additives can be present in amounts up to 20 wt.-% based on the total weight of the polyurethane resin composition.

In one embodiment, the polyurethane resin composition, as described hereinabove, can also comprise a reinforcing agent. Suitable reinforcing agents refer to fillers in the present context.

Suitable fillers include, such as, but not limited to, silicatic minerals, examples being finely ground quartzes, phyllosilicates, such as antigorite, serpentine, hornblendes, amphibols, chrysotile, and talc; metal oxides, such as kaolin, aluminum oxides, aluminium hydroxides, magnesium hydroxides, hydromagnesite, titanium oxides and iron oxides, metal salts such as chalk, heavy spar and inorganic pigments, such as cadmium sulfide, zinc sulfide, and also glass and others. Preference is given to using kaolin (china clay), finely ground quartzes, aluminum silicate, and coprecipitates of barium sulfate and aluminum silicate.

Suitable fillers have an average particle diameter in between 0.1 μm to 500 μm, or 1 μm to 100 μm, or 1 μm to 10 μm. Diameter in this context, in the case of non-spherical particles, refers to their extent along the shortest axis in space.

Suitable amounts of the fillers can be present in the polyurethane resin composition which are known to the person skilled in the art. For instance, fillers can be present in an amount up to 50 wt.-%, based on the total weight of the polyurethane resin composition.

In another embodiment, in the panel construction, as described hereinabove, there is no requirement of an adhesive and/or a fastening means to bind the polyurethane film onto the at least one fiber mat layer. Advantages associated with the absence of an adhesive and/or fastening means are control on the thickness of the panel construction and faster and economical production of the panel construction. The panel constructions have improved properties, particularly impact performance, in accordance with the requirements of General Motors Worldwide (GMW) and Ford Motor Company.

In yet another embodiment, the panel construction, as described herein, are thinner and lighter than the existing honeycomb sandwich panels due to the absence of any honeycomb structure in them. This provides for the panel construction being used in applications which require thin composites without compromising on their mechanical properties and chemical resistance. In particular, the panel construction is capable of meeting the requirements of GMW, Ford Motor Company and SAE, such as but not limited to, GMW 14864, FLTM BI 168-01, GMW 14334, SAE J369, GMW 16600, GMW 14729, WSS-M99P32-E4-E5 and GMW 16381 3.8. These standards provide for procedures to determine the performance of the panel construction when subjected to various conditions and are known to the person skilled in the art.

Other advantages of the panel construction are that they are mechanically stable, are seamless panels, can employ a variety of colours via incorporation of pigments, are field repairable with auto body techniques, have good thermal shock resistance, have high strength/low weight, have easy handling and mobility, reduce production steps, have high sound damping, are weather and moisture resistant and are non-permeable. Further, the panel constructions result in less warpage or in fact no warpage, which is beneficial for storage or shipping during hot climate.

In another embodiment, the panel construction can further comprise additional materials, disposed on the said panel construction using suitable techniques known to the person skilled in the art. These additional materials can be, such as, but not limited to, polyisocyanate polyaddition products. By the term “polyisocyanate polyaddition products”, it is referred to the reaction products of suitable amounts of polyisocyanates and compounds reactive towards isocyanate having preferably a molecular weight of 500 g/mol or more.

The polyisocyanate polyaddition products include, but are not limited to, cellular polyurethane elastomers and flexible, semi rigid or rigid polyurethane foams. In an embodiment, at least one of the polyisocyanate polyaddition product, such as, but not limited to, polyurethane-ureas, open and closed polyurethane foams can be disposed on the panel construction. For instance, the polyisocyanate polyaddition products can be disposed as additional layers or sprayed or impregnated on the panel construction. The addition of these polyisocyanate polyaddition products further enhances the mechanical properties of the panel construction and renders it suitable for use, such as, but not limited to, in the automotive industry.

In an embodiment, the above described process is a spray transfer molding process.

In step (S1), the spraying of the polyurethane resin composition obtained by reacting the isocyanate and the compound reactive towards isocyanate refers to a two-component system which comprises of an isocyanate component and a component comprising the compounds reactive towards isocyanate. In one embodiment, the two-component system comprises the isocyanate component and the polyol component. By the term “component”, it is referred to the mixture comprising isocyanates along with catalysts, additives and fillers and polyol along with catalysts, additives and fillers, as described hereinabove. The presence of catalysts, additives and fillers in the polyol component and/or the isocyanate component is optional and depends on the desired properties of the final polyurethane resin composition. In an exemplary embodiment, the polyol component can comprise polyols, catalysts, additives and fillers, while the isocyanate component is majorly comprised of isocyanates, as described hereinabove.

In another embodiment, a multicomponent system comprising more than two components, as described hereinabove, can also be employed. For instance, in addition to the conventionally used polyol component and the isocyanate component, at least one additional component can be present. Suitable compounds for the additional components can be selected from compounds reactive towards isocyanate, isocyanates, catalysts, additives, fillers and mixtures thereof. In one embodiment, the at least one additional component is different from the polyol component and the isocyanate component.

Spraying of the polyurethane resin composition onto the at least one fiber mat layer in the step (S1) can be carried out using suitable means well known to the person skilled in the art. However, the isocyanate and the component reactive towards isocyanate can be mixed in a mixing device to obtain a reactive mixture before spraying it onto the at least one fiber mat layer as the polyurethane composition to obtain the pre-impregnated blank. Suitable mixing device for this purpose are preferably a mixing head or a static mixer.

In an exemplary embodiment, a reaction mixture is obtained by feeding at least two streams into the mixing device, wherein:
(i) a first stream comprises at least one isocyanate component, and
(ii) a second stream comprises at least one polyol component,
wherein at least one of the catalyst, the additive and the filler is present in at least one of (i) and (ii).

In one embodiment, the isocyanate component and the polyol component are present at an isocyanate index in between 100 to 150. In another embodiment, the isocyanate index is in between 100 to 140, or in between 100 to 130, or in between 100 to 120. In another embodiment, it is in between 100 to 115, or in between 105 to 115.

Suitable temperatures for processing the reaction mixture are well known to the person skilled in the art. In one embodiment, the first stream and the second stream, independent of each other, can be premixed in suitable mixing means, such as, but not limited to, a static mixer.

The mixing device can be a low pressure or high pressure mixing device comprising:
pumps to feed the streams,
a high pressure mixing head in which the streams, as described hereinabove, are mixed,
a first feed line fitted to the high pressure mixing head through which the first stream is introduced into the mixing head, and
a second feed line fitted to the high pressure mixing head through which the second stream is introduced into the mixing head.

Optionally, the mixing device, as described hereinabove, can further comprise at least one measurement and control unit for establishing the pressures of each feed lines in the mixing head. Also, the term “low pressure” here refers to a pressure in between 0.1 MPa to 5 MPa, while the term “high pressure” refers to pressure above 5 MPa.

In one embodiment, the reaction mixture is passed from the mixing head into the mixing device. A solid/gas mixture can be added through additional inlets. By “solid”, it is referred to the fillers, as described hereinabove, which are in a solid state of matter.

The reaction mixture obtained from the mixing device is fed to the spraying means. Suitable spraying means include, but are not limited to, spray heads. In one embodiment, the spray head for spraying the polyurethane resin composition comprises at least one polyurethane spray jet. The polyurethane spray jet essentially consists of fine particles or droplets of the polyurethane resin composition, i.e. of the reaction mixture, preferably dispersed in the gas stream. Such a polyurethane spray jet can be obtained in different ways, for example, by atomizing a liquid jet of the reaction mixture of the polyurethane resin composition by a gas stream introduced into it, or by the ejection of a liquid jet of the reaction mixture from a corresponding nozzle or atomizer. By the term “liquid jet of the reaction mixture”, it is referred to the fluid jet of the reaction mixture of the polyurethane resin composition that is not yet in the form of fine reaction mixture droplets dispersed in a gas stream, i.e. especially in a liquid viscous phase. Thus, in particular, such a “liquid jet of the reaction mixture” does not mean a polyurethane spray jet, as described above. Such methods are described, for example in, DE 10 2005 048 874 A1, DE 101 61 600 A1, WO 2007/073825 A2, U.S. Pat. No. 3,107,057 A and DE 1 202 977 B.

Alternatively, a solid containing gas stream can also be employed instead of the gas stream, as described hereinabove. The solid-containing gas stream can be prepared by passing the gas stream through solid-containing metering cells of a cellular wheel sluice. By the flushing of the cellular spaces, the solid is dragged along by the pressurized air stream and transported to the mixing head as a solid/air or solid/gas mixture. To avoid pulsation, the channel inside the metering sluice must be designed with a diameter that excludes positive overlap. This embodiment further ensures that a quantitatively unchanged air flow rate for spraying the reaction mixture is available even when the cellular wheel sluice metering is turned off of its revolutions per minute is changed, and thus spraying can be effected alternatively without or with variable filler quantities. As a particular advantage of such a cellular wheel sluice, the solid proportion in the pre-impregnated blank to be prepared can be variably adjusted.

The polyurethane spray jet, as described hereinabove, impinges on a spray area oscillating with an adjustable amplitude of less than 500 mm. By the term “spray area”, it is referred to the target area of the at least one fiber mat layer.

During the spraying, the at least one fiber mat layer is wetted with the polyurethane resin composition. In one embodiment, spraying of the polyurethane resin composition is done on both the sides of the at least one fiber mat layer.

Handling of the at least one fiber mat layer can be either manually or automatically. By the term “automatically”, it is referred to the handling of the at least one fiber mat layer via a human interface, for instance, using industrial robots. In a preferred embodiment, an industrial robot that has preferably 6 axes and is especially tailored for production facilities using flexible robot-controller automation is employed. The robot is operated by means of a process software incorporated into a control cabinet. The control is suitable for communicating with external control systems. The robot can be equipped with a highly developed dual port safety system, the functions of which are continuously monitored. In case of a failure or malfunction, the electric supply of the motors can be switched off and brakes activated. Furthermore, the movement of each axes can be limited by software functions. In a preferred embodiment, the robot is driven via brushless three phase servomotors with brakes on all axes.

The pre-impregnated blank obtained in step (S1) is subsequently compression moulded in step (S2), for example, in a heated compression molding tool and is compressed in accordance with the required panel construction geometry and hardened. Subsequently, it is optionally possible, while the panel construction is left in the compression molding tool, for a contour cut, that is to say, coarse cutting to shape, to be performed around the tool or around the tool geometry.

In another embodiment, it is also possible, if necessary, for the panel construction to be cooled or thermally stabilized in the compression molding tool or outside the compression molding tool, preferably cooled or thermally stabilized in a further tool, in particular in a workpiece cooling device.

In accordance with the embodiments, “thermally stabilized” is to be understood to mean that the panel construction assumes a temperature below the previous conversion temperature in order to attain a stable state. Here, the cooling in a workpiece cooling device makes it possible to realize the shortest production time, in particular with regard to continuous production of only one panel construction.

In another embodiment, tempering of the panel construction, that is to say a temperature process, in order for distortions to be compensated and/or the level of cross-linking of the materials to be increased, is performed in a further tool or in a further device. For example, it may be provided that, for cooling, the panel construction is merely placed on a frame or by way of one side on a surface. Use may however also be made of a closed cooling device which surrounds the panel construction around the full circumference and in which the temperature can be regulated. Further cooling of the panel construction can optionally be performed.

In yet another embodiment, the cooling can be followed by trimming of the outer contour, or cutting to shape of the side regions/edges, in accordance with the required panel construction contour and optionally also a chip-removing machining process, such as, for example, milling of the outer contour and milling and drilling for inserts and other similar recesses in the panel construction.

Yet another aspect of the present invention relates to the panel construction obtained according to the above described process.

Another aspect of the present invention relates to the use of the panel construction, as described hereinabove, as an automotive part. In an embodiment, the automotive parts are selected from lower sound shield, acoustical belly pan, aero shield, splash shield, underbody panel, chassis shield, door module, rear package and leaf spring.

Yet another aspect of the present invention relates to an automotive part comprising the panel construction, as described hereinabove.

Still another aspect of the present invention relates to a lower sound shield comprising the panel construction, as described hereinabove.

Another aspect of the present invention relates to an acoustical belly pan comprising the panel construction, as described hereinabove.

Yet another aspect of the present invention relates to an aero shield comprising the panel construction, as described hereinabove.

Still another aspect of the present invention relates to a splash shield comprising the panel construction, as described hereinabove.

Another aspect of the present invention relates to an underbody panel comprising the panel construction, as described hereinabove.

Yet another aspect of the present invention relates to a chassis shield comprising the panel construction, as described hereinabove.

Still another aspect of the present invention relates to a rear package shelf comprising the panel construction, as described hereinabove.

Still further aspect of the present invention relates to a leaf spring comprising the panel construction, as described hereinabove.

The present invention is illustrated in more detail by the following embodiments and combinations of embodiments which result from the corresponding dependency references and links:

1. A panel construction comprising:
(A) at least one fiber mat layer, and
(B) a polyurethane film prepared from a polyurethane resin composition obtained by reacting:
   (a) an isocyanate, and
   (b) a compound reactive towards isocyanate,
   wherein (a) and (b) are present at an isocyanate index in between 100 to 150, and
wherein the polyurethane resin composition is sprayed onto the at least one fiber mat layer to form the polyurethane film.

2. The panel construction according to embodiment 1, wherein the panel construction has a thickness in between 1 mm to 30 mm.

3. The panel construction according to embodiment 1 or 2, wherein the fiber mat layer has an area weight in between 100 g/m²to 1500 g/m².

4. The panel construction according to one or more of embodiments 1 to 3, wherein the fiber mat layer is made of non-woven cellulosic bast fiber, non-woven polyester fiber or glass fiber.

5. The panel construction according to embodiment 4, wherein the fiber mat layer is made of glass fiber.

6. The panel construction according to embodiment 5, wherein the glass fiber is a continuous glass fiber or chopped glass fiber.

7. The panel construction according to one or more of embodiments 1 to 6, wherein the isocyanate comprises an aliphatic isocyanate or an aromatic isocyanate or a combination thereof.

8. The panel construction according to embodiment 7, wherein the isocyanate is an aromatic isocyanate.

9. The panel construction according to embodiment 8, wherein the aromatic isocyanate comprises toluene diisocyanate; polymeric toluene diisocyanate, methylene diphenyl diisocyanate; polymeric methylene diphenyl diisocyanate, m-phenylene diisocyanate; 1,5-naphthalene diisocyanate; 4-chloro-1; 3-phenylene diisocyanate; 2,4,6-toluylene triisocyanate, 1,3-diisopropylphenylene-2,4-diisocyanate; 1-methyl-3,5-diethylphenylene-2,4-diisocyanate; 1,3,5-triethylphenylene-2,4-diisocyanate; 1,3,5-triisoproply-phenylene-2,4-diisocyanate; 3,3′-diethyl-bisphenyl-4,4′-diisocyanate; 3,5,3′,5′-tetraethyl-diphenylmethane-4,4′-diisocyanate; 3,5,3′,5′-tetraisopropyldiphenylmethane-4,4′-diisocyanate; 1-ethyl-4-ethoxy-phenyl-2,5-diisocyanate; 1,3,5-triethylbenzene-2,4,6-triisocyanate; 1-ethyl-3,5-diisopropyl ben-zene-2,4,6-triisocyanate, tolidine diisocyanate and 1,3,5-triisopropyl benzene-2,4,6-triisocyanate or a combination thereof.

10. The panel construction according to embodiment 9, wherein the aromatic isocyanate comprise methylene diphenyl diisocyanate, polymeric methylene diphenyl diisocyanate or a combination thereof.

11. The panel construction according to one or more of embodiments 1 to 10, wherein the polyurethane composition has an isocyanate index in between 100 to 120.

12. The panel construction according to one or more of embodiments 1 to 11, wherein the compound reactive towards isocyanate has a molecular weight of 400 g/mol or more.

13. The panel construction according to one or more of embodiments 1 to 12, wherein the compound reactive towards isocyanate is a polyol having an average functionality in between 2.0 to 8.0 and hydroxyl number in between 15 mg KOH/g to 1800 mg KOH/g.

14. The panel construction according to embodiment 13, wherein the polyol comprises of polyether polyol, polyester polyol, polyether-ester polyol or a combination thereof.

15. The panel construction according to embodiment 14, wherein the polyol is a polyether polyol.

16. The panel construction according to one or more of embodiments 1 to 15, wherein the polyurethane resin composition comprises the compound reactive towards isocyanate in an amount in between 1 wt. % to 99 wt. %, related to the overall weight of the polyurethane composition.

17. The panel construction according to one or more of embodiments 1 to 16, wherein the polyurethane resin composition further comprises a chain extender and/or cross linker having a molecular weight between 49 g/mol to 399 g/mol.

18. The panel construction according to one or more of embodiments 1 to 17, wherein the polyurethane resin composition further comprises catalysts, additives and fillers.

19. The panel construction according to embodiment 18, wherein the additives can be selected from pigments, dyes, surfactants, flame retardants, hindered amine light stabilizers, ultraviolet light absorbers, stabilizers, defoamers, internal release agents, desiccants, blowing agents, curing agents and antistatic agents or a combination thereof.

20. The panel construction according to one or more of embodiments 1 to 19, which is a single-layer system comprising (A) the at least one fiber mat layer and (B) the polyurethane film.

21. The panel construction according to one or more of embodiments 1 to 20, wherein the panel construction does not contain any adhesive between (A) the at least one fiber mat layer and (B) the polyurethane film.

22. A process for preparing a panel construction, said process comprising the steps of:
(S1) spraying a polyurethane resin composition onto at least one fiber mat layer, wherein said polyurethane resin composition is obtained by reacting:
   (a) an isocyanate, and
   (b) a compound reactive towards isocyanate;
   wherein (a) and (b) are present at an isocyanate index in between 100 to 150, and
   wherein said polyurethane resin composition forms a polyurethane film on the at least one fiber mat layer;
   and resulting in a pre-impregnated blank,
   and
(S2) compression molding the pre-impregnated blank and resulting in the panel construction.

23. The process according to embodiment 22, wherein the polyurethane resin composition is atomized.

24. The process according to embodiment 22 or 23, wherein the process is a spray transfer molding process.

25. A panel construction obtained according to the process of one or more of embodiments 22 to 24.

26. Use of the panel construction according to one or more of embodiments 1 to 21 or as obtained by the process according to one or more of embodiments 22 to 24 as an automotive part.

27. The use according to embodiment 26, wherein the automotive part is selected from lower sound shield, acoustical belly pan, aero shield, splash shield, underbody panel, chassis shield, door module, rear package shelf and leaf spring.

28. An automotive part comprising the panel construction according to one or more of embodiments 1 to 21 or as obtained by the process according to one or more of embodiments 22 to 24.

29. A lower sound shield comprising the panel construction according to one or more of embodiments 1 to 21 or as obtained by the process according to one or more of embodiments 22 to 24.

30. An acoustical belly pan comprising the panel construction according to one or more of embodiments 1 to 21 or as obtained by the process according to one or more of embodiments 22 to 24.

31. An aero shield comprising the panel construction according to one or more of embodiments 1 to 21 or as obtained by the process according to one or more of embodiments 22 to 24.

32. A splash shield comprising the panel construction according to one or more of embodiments 1 to 21 or as obtained by the process according to one or more of embodiments 22 to 24.

33. An underbody panel comprising the panel construction according to one or more of embodiments 1 to 21 or as obtained by the process according to one or more of embodiments 22 to 24.

34. A chassis shield comprising the panel construction according to one or more of embodiments 1 to 21 or as obtained by the process according to one or more of embodiments 22 to 24.

35. A rear package shelf comprising the panel construction according to one or more of embodiments 1 to 21 or as obtained by the process according to one or more of embodiments 22 to 24.

36. A leaf spring comprising the panel construction according to one or more of embodiments 1 to 21 or as obtained by the process according to one or more of embodiments 22 to 24.

37. A process for preparing a panel construction, said process comprising the steps of:
(S1) spraying a polyurethane resin composition onto at least one fiber mat layer, wherein said polyurethane resin composition is obtained by reacting:
   (a) an isocyanate, and
   (b) a compound reactive towards isocyanate;
   wherein (a) and (b) are present at an isocyanate index in between 100 to 150, and wherein said polyurethane resin composition forms a polyurethane film on the at least one fiber mat layer;
   and resulting in a pre-impregnated blank,
   and
(S2) compression molding the pre-impregnated blank and resulting in the panel construction.

38. The process according to embodiment 37, wherein the panel construction is a single-layer system comprising the at least one fiber mat layer and the polyurethane film.

39. The process according to embodiment 37 or 38, wherein the polyurethane resin composition is atomized.

40. The process according to one or more of embodiments 37 to 39, wherein the process is a spray transfer molding process.

41. The process according to one or more of embodiments 37 to 40, wherein the panel construction has a thickness in between 1 mm to 30 mm.

42. The process according to one or more of embodiments 37 to 41, wherein the fiber mat layer has an area weight in between 100 g/m² to 1500 g/m².

43. The process according to one or more of embodiments 37 to 42, wherein the fiber mat layer is made of glass fibers.

44. The process according to one or more of embodiments 37 to 43, wherein the isocyanate index is in between 100 to 120.

45. The process according to one or more of embodiments 37 to 44, wherein the isocyanate is aromatic isocyanate.

46. The process according to embodiment 45, wherein the aromatic isocyanate comprises methylene diphenyl diisocyanate and/or polymeric methylene diphenyl diisocyanate.

47. The process according to one or more of embodiments 37 to 46, wherein the compound reactive towards isocyanate has a molecular weight of 400 g/mol or more.

48. The process according to one or more of embodiments 37 to 47, wherein the compound reactive towards isocyanate is a polyol having an average functionality in between 2.0 to 8.0 and hydroxyl number in between 15 mg KOH/g to 1800 mg KOH/g.

49. The process according to embodiment 48, wherein the polyol comprises of polyether polyol, polyester polyol, polyether-ester polyol or a combination thereof.

50. The process according to embodiment 49, wherein the polyol is a polyether polyol.

51. The process according to one or more of embodiments 37 to 50, wherein the polyurethane resin composition comprises the compound reactive towards isocyanate in an amount in between 1 wt. % to 99 wt. %, related to the overall weight of the polyurethane composition.

52. The process according to one or more of embodiments 37 to 51, wherein the polyurethane resin composition further comprises a chain extender and/or cross linker having a molecular weight between 49 g/mol to 399 g/mol.

53. The process according to one or more of embodiments 1 to 52, wherein the polyurethane resin composition further comprises catalysts, additives and fillers.

54. The process according to embodiment 53, wherein the additives can be selected from pigments, dyes, surfactants, flame retardants, hindered amine light stabilizers, ultraviolet light absorbers, stabilizers, defoamers, internal release agents, desiccants, blowing agents, curing agents and anti-static agents or a combination thereof.

55. The process according to one or more of embodiments 37 to 54, wherein the panel construction does not contain any adhesive between the at least one fiber mat layer and the polyurethane film.

56. A panel construction obtained according to the process of one or more of embodiments 37 to 55.

57. Use of the panel construction according to embodiment 56 or as obtained by the process according to one or more of embodiments 37 to 55 as an automotive part.

58. The use according to embodiment 57, wherein the automotive part is selected from a lower sound shield, acoustical belly pan, aero shield, splash shield, underbody panel, chassis shield, door module, rear package shelf and leaf spring.

59. An automotive part comprising the panel construction according to embodiment 56 or as obtained by the process according to one or more of embodiments 37 to 55.

60. A lower sound shield comprising the panel construction according to embodiment 56 or as obtained by the process according to one or more of embodiments 37 to 55.

61. An acoustical belly pan comprising the panel construction according to embodiment 56 or as obtained by the process according to one or more of embodiments 37 to 55.

62. An aero shield comprising the panel construction according to embodiment 56 or as obtained by the process according to one or more of embodiments 37 to 55.

63. A splash shield comprising the panel construction according to embodiment 56 or as obtained by the process according to one or more of embodiments 37 to 55.

64. An underbody panel comprising the panel construction according to embodiment 56 or as obtained by the process according to one or more of embodiments 37 to 55.

65. A chassis shield comprising the panel construction according to embodiment 56 or as obtained by the process according to one or more of embodiments 37 to 55.

66. A rear package shelf comprising the panel construction according to embodiment 56 or as obtained by the process according to one or more of embodiments 37 to 55.

67. A leaf spring comprising the panel construction according to embodiment 56 or as obtained by the process according to one or more of embodiments 37 to 55.

### EXAMPLES

Compounds

Polyurethane resin composition
Isocyanate

| | |
|---|---|
| Isocyanate | Methylene diphenyl diisocyanate having NCO |
| (100 wt.-%) | content of 33.5 wt.-%, obtained from BASF |

Compound reactive towards isocyanate

| | |
|---|---|
| Polyol | Mixture of: |
| (71.5 wt.-%) | Polyether polyol with pentaerythritol as |
| | the starter molecule and propylene oxide |
| | end capping, having the average functionality |
| | of 4.0 and hydroxyl number of 555 mg KOH/g, |
| | obtained from BASF Polyether polyol with |
| | sucrose and glycerol as the starter molecule |
| | and propylene oxide end capping, having the |
| | average functionality of 4.5 and hydroxyl number |
| | of 368 mg KOH/g, obtained from BASF |
| | Polyether polyol with trimethylolpropane as |
| | the starter molecule and ethylene oxide end capping, |
| | having the average functionality |
| | of 3.0 and hydroxyl number of 920 mg KOH/g, obtained |
| | from BASF |
| Chain extender | Ethylene glycol |
| (12 wt.-%) | |
| Additives | Water as blowing agent, |
| (16.5 wt.-%) | Ethacure ® 100 obtained from Albemarle Corporation, |
| | Repitan ® 99430 obtained from Repi SpA and |
| | Tegostab ® B8443 obtained from Evonik |
| Fiber mat layer | Glass fiber mat having an area weight of 300 to 600 g/m² |

Standard Methods

| | |
|---|---|
| Impact resistance | GMW16381, GMW14903 |
| Gravelometer procedure | GMW14700 |
| Preconditioning of samples | GMW3221 |
| Sulfur dioxide and hydrogen | GMW 14864 |
| sulfide staining | |
| Resistance to cleaning agents | GMW 14334 |
| Flammability | SAE J369 |
| Susceptibility to chloride stress | GMW 16600 |
| corrosion cracking | |
| Resistance to humidity | GMW 14729 |
| Resistance to mildew | WSS-M99P32-E4-E5 |
| Moisture absorption | WSS-M99P32-E4-E5 |
| Water and slash resistance | GMW 16381 3.8 |

General Synthesis of Test Samples

Inventive sample was obtained using the two-component system comprising the isocyanate component and the polyol component, as above. The two components were subjected to the mixing device at the isocyanate index of 108. The polyurethane resin composition was subsequently sprayed on the fiber mat.

The fiber mat with varying dimensions was positioned on fixtures. The robotic end of arm tooling held the fiber mat and placed it below the polyurethane spray head. The polyurethane resin composition was sprayed on both sides of the fiber mat and subsequently positioned under a heated mold to form and cure the test sample. The temperature and pressure of the mold were kept at 120° C.

Direct long fiber thermoplastic polypropylene (DLFT PP) comprising 40 wt.-% glass fiber rovings was used for comparison.

The inventive and comparative samples were subjected to impact toughness measurement. Table 1 below shows a summary of the results obtained.

TABLE 1
Test summary of both inventive samples
(IS) and comparative samples (CS)

| | Sample dimension | | |
|---|---|---|---|
| | (length × breadth × | | |
| Sample | thickness), in mm | Impact toughness | Result |
| CS 1 | 130 × 130 × 3 | At 23° C. ± 5° C., | Failed - cracking in |
| | | set to 10 J | impact area |
| CS 2 | 130 × 130 × 3 | At −30° C. ± 3° C., | Failed - cracking in |
| | | set to 5 J | impact area |
| IS 1 | 140 × 140 × 1 | At 23° C. ± 5° C., | Passed - no cracking |
| | | set to 10 J | |
| IS 2 | 140 × 140 × 1 | At −30° C. ± 3° C., | Passed - no cracking |
| | | set to 5 J | |
| IS 3 | 200 × 140 × 1 | At 23° C. ± 5° C., | Passed - no cracking |
| | | set to 12.5 J | |

The comparative sample CS 1, when subjected to impact toughness measurement at 23° C.±5° C. and 10 J, could not pass the test and reported cracks on the impact area. On the other hand, the inventive sample IS 1, although with lesser thickness than CS 1, at 23° C.±5° C. and 10 J, did not crack and passed the test.

General Synthesis of Underbody Panels

Underbody panel was also obtained with the fiber mat and the polyurethane resin composition, as described herein. The polyurethane resin composition was sprayed on the fiber mat, similar to obtaining test samples. The fiber mat, with polyurethane resin composition sprayed on both the sides, was positioned under a heated mold to obtain the underbody panel having dimensions of 101.6 mm×304.8 mm×1 mm.

The underbody panel was subjected to impact resistance in accordance with GMW16381 and GMW14903. The test panel was preconditioned in accordance with GMW3221, prior to testing for the impact resistance. The procedure described in GMW14700 method B was selected. Sample was subjected to 100 kg of gravel impingement at 90° impact angle, after 16 h at 23° C. and 50% relative humidity. The panel was rated based on maximum stone impact diameter (in mm) at temperatures of 23° C.±5° C. and −18° C.±2° C. A rating of 10, on a scale of 1 to 10, implied no chips and surface marks on the panel, while less than 6 referred to poor quality panels. In order for the underbody panel to be used for automotive application, ratings above 9+were desired, which were achievable by the underbody panel in accordance with the present invention.

Additionally, the underbody panel was also subjected to various chemical resistance tests. The results of the test are summarized in Table 2. As evident in Table 2, the underbody panel provides for acceptable chemical resistance and can therefore be advantageously used in automotives.

TABLE 2
Chemical resistance test summary

| Description | Test result |
|---|---|
| Sulfur dioxide and hydrogen | NC |
| sulfide staining | |
| Resistance to cleaning agents | Rating 4 - NC |
| Flammability | Self-extinguishing |
| Susceptibility to chloride | Passed |
| stress corrosion cracking | |
| Resistance to humidity | Passed |
| Resistance to mildew | Passed - no mildew |
| Moisture absorption | Passed - 0.34% |
| Water and slash resistance | Passed - 0.20% |

*NC = no contamination

1. A process for preparing a panel construction, said process comprising the steps of:
(S1) spraying a polyurethane resin composition onto at least one fiber mat layer, wherein said polyurethane resin composition is obtained by reacting:
(a) an isocyanate, and
(b) a compound reactive towards isocyanate;
wherein (a) and (b) are present at an isocyanate index in between 100 to 150, and
wherein said polyurethane resin composition forms a polyurethane film on the at least one fiber mat layer;
and resulting in a pre-impregnated blank,
and
(S2) compression molding the pre-impregnated blank and resulting in the panel construction,
wherein the polyurethane resin composition is a rigid polyurethane foam, and wherein the panel construction has a thickness in between 1 mm and 30 mm.

2. The process according to claim 1, wherein the panel construction is a single-layer system comprising the at least one fiber mat layer and the polyurethane film.

3. The process according to claim 1, wherein the polyurethane resin composition is atomized.

4. The process according to claim 1, wherein the process is a spray transfer molding process.

5. The process according to claim 1, wherein the fiber mat layer has an area weight in between 100 g/m² to 1500 g/m².

6. The process according to claim 1, wherein the fiber mat layer is made of glass fibers.

7. The process according to claim 1, wherein the isocyanate index is in between 100 to 120.

8. The process according to claim 1, wherein the isocyanate is aromatic isocyanate.

9. The process according to claim 8, wherein the aromatic isocyanate comprises methylene diphenyl diisocyanate and/or polymeric methylene diphenyl diisocyanate.

10. The process according to claim 1, wherein the compound reactive towards isocyanate is a polyol having an average functionality in between 2.0 to 8.0 and hydroxyl number in between 15 mg KOH/g to 1800 mg KOH/g.

11. The process according to claim 10, wherein the polyol is a polyether polyol.

12. The process according to claim 1, wherein the polyurethane resin composition further comprises a chain extender and/or cross linker having a molecular weight between 49 g/mol to 399 g/mol.

13. The process according to claim 1, wherein the polyurethane resin composition further comprises catalysts, additives, and fillers.

14. The process according to claim 13, wherein the additives are selected from the group consisting of pigments, dyes, surfactants, flame retardants, hindered amine light stabilizers, ultraviolet light absorbers, stabilizers, defoamers, internal release agents, desiccants, blowing agents, curing agents, anti-static agents and a combination thereof.

15. The process according to claim 1, wherein the panel construction does not contain any adhesive between the at least one fiber mat layer and the polyurethane film.

16. A panel construction obtained according to the process of claim 1.

17. A method of using the panel construction according to claim 16, the method comprising using the panel construction as an automotive part.

18. The method of use according to claim 17, wherein the automotive part is selected from the group consisting of a lower sound shield, acoustical belly pan, aero shield, splash shield, underbody panel, chassis shield, door module, rear package shelf and leaf spring.

19. An automotive part comprising the panel construction according to claim 16.

20. (canceled)
